(19) United States
(12) Patent Application Publication
(10) Pub. No.: US 2026/0004642 A1
(43) Pub. Date: Jan. 1, 2026

(54) SYSTEMS AND METHODS OF ELECTRONIC GAMING INCLUDING RANDOM MYSTERY SYMBOL COLLECTION TRIGGER

(71) Applicant: Aristocrat Technologies Australia Pty Limited, North Ryde (AU)

(72) Inventor: Scott Olive, Brookvale (AU)

(21) Appl. No.: 18/810,229

(22) Filed: Aug. 20, 2024

(30) Foreign Application Priority Data
Jun. 28, 2024 (AU) 2024901979

(51) Int. Cl. G07F 17/32; G06F 7/58

(52) U.S. Cl. CPC G07F 17/3267; G06F 7/588; G07F 17/3213

(57) ABSTRACT

An electronic gaming system including a memory and a processor in is described. The processor is configured to cause an electronic game including a designated symbol counter to be provided and cause the designated symbol counter to be incremented. The processor is also configured to, based upon the designated symbol counter reaching a trigger value stored in the memory, cause a feature game to be triggered, randomly determine a reset value for the designated symbol counter based upon a first random number generator (RNG) call and a first range of values stored in the memory, and randomly determine a reset trigger value based upon a second RNG call and a second range of values stored in the memory, the second range of values including a range between the reset value and a maximum value.

### CROSS REFERENCE TO RELATED APPLICATIONS

This application claims the benefit of priority to Australia Patent Application No. 2024901979, filed Jun. 28, 2024, the contents of which are hereby incorporated by reference herein in their entirety.

### FIELD

The present application relates to a gaming device, a method of operating a gaming device and a system with a mystery symbol collection trigger.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In many games, a player may qualify for secondary games or bonus rounds by attaining a certain winning combination or triggering event in the base game. Secondary games provide an opportunity to win additional game instances, credits, awards, jackpots, progressives, etc. Awards from any winning outcomes are typically added back to the credit balance and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for ready identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player (RTP=return to player) over the course of many plays or instances of the game. The RTP and randomness of the RNG are critical to ensuring the fairness of the games and are therefore highly regulated. Upon initiation of play, the RNG randomly determines a game outcome and symbols are then selected which correspond to that outcome. Notably, some games may include an element of skill on the part of the player and are therefore not entirely random.

### SUMMARY

In one aspect, an electronic gaming system including at least one memory with instructions stored thereon and at least one processor in communication with the at least one memory is described. The instructions, when executed by the at least one processor, cause the at least one processor to cause an electronic game including a designated symbol counter to be provided and cause the designated symbol counter to be incremented based upon display of one or more designated symbols during play of the electronic game. The instructions also cause the at least one processor to, based upon the designated symbol counter reaching a trigger value stored in the at least one memory, cause a feature game to be triggered, randomly determine a reset value for the designated symbol counter based upon a first random number generator (RNG) call and a first range of values stored in the at least one memory, and randomly determine a reset trigger value based upon a second RNG call and a second range of values stored in the at least one memory, the second range of values including a range between the reset value and a maximum value.

In another aspect, at least one non-transitory computer-readable storage medium with instructions stored thereon is described. The instructions, in response to execution by at least one processor, cause the at least one processor to cause an electronic game including a designated symbol counter to be provided and cause the designated symbol counter to be incremented based upon display of one or more designated symbols during play of the electronic game. The instructions also cause the at least one processor to, based upon the designated symbol counter reaching a trigger value stored in the at least one non-transitory computer-readable storage medium, cause a feature game to be triggered, randomly determine a reset value for the designated symbol counter based upon a first random number generator (RNG) call and a first range of values stored in the at least one non-transitory computer-readable storage medium, and randomly determine a reset trigger value based upon a second RNG call and a second range of values stored in the at least one non-transitory computer-readable storage medium, the second range of values including a range between the reset value and a maximum value.

In another aspect, a method of electronic gaming implemented by at least one processor in communication with at least one memory is described. The method includes causing an electronic game including a designated symbol counter to be provided and causing the designated symbol counter to be incremented based upon display of one or more designated symbols during play of the electronic game. The method also includes, based upon the designated symbol counter reaching a trigger value stored in the at least one memory, causing a feature game to be triggered, randomly determining a reset value for the designated symbol counter based upon a first random number generator (RNG) call and a first range of values stored in the at least one memory, and randomly determining a reset trigger value based upon a second RNG call and a second range of values stored in the at least one memory, the second range of values including a range between the reset value and a maximum value.

There is disclosed a gaming device, a method of operating a gaming device and a system with a mystery symbol collection trigger of a feature game.

An example embodiment describes a gaming device including a display, a random number generator, a processor, and a memory storing reel strip data, a designated symbol counter, and instructions. When the instructions are executed by the processor, they cause the processor to conduct a game instance by selecting, using the random number generator, symbols from a plurality of reel strips defined by the reel strip data for display at a plurality of symbol positions, upon the selected symbols including at least one designated symbol, increment the designated symbol counter for each designated symbol at least until the current symbol trigger value is reached, upon the current symbol trigger value being reached, award a feature game including at least one additional game instance, and reset the current symbol trigger value by selecting, using the random number generator, a new current symbol trigger value from a set of symbol trigger values.

Another example embodiment describes a method of operating a gaming device including a display, memory storing reel strip data and a designated symbol counter, and a random number generator. The method includes conducting a game instance by selecting, using the random number generator, symbols from a plurality of reel strips defined by the reel strip data for display at a plurality of symbol positions, upon the selected symbols including at least one designated symbol, incrementing the designated symbol counter for each designated symbol at least until the current symbol trigger value is reached, upon the current symbol trigger value being reached, awarding a feature game including at least one additional game instance, and resetting the current symbol trigger value by selecting, using the random number generator, a new current symbol trigger value from a set of symbol trigger values

Another example embodiment describes a system including at least one display, a random number generator, one or more processors, and at least one memory storing reel strip data, a designated symbol counter, and instructions. When the instructions are executed by the one or more processors, they cause the one or more processors to conduct a game instance by selecting, using the random number generator, symbols from a plurality of reel strips defined by the reel strip data for display at a plurality of symbol positions, upon the selected symbols including at least one designated symbol, increment the designated symbol counter for each designated symbol at least until the current symbol trigger value is reached, upon the current symbol trigger value being reached, award a feature game including at least one additional game instance, and reset the current symbol trigger value by selecting, using the random number generator, a new current symbol trigger value from a set of symbol trigger values.

### BRIEF DESCRIPTION OF THE DRAWINGS

FIG. 1 is an exemplary diagram showing several EGMs networked with various gaming related servers.

FIG. 2 is a block diagram showing various functional elements of an exemplary EGM.

FIG. 3 illustrates an example reel strip layout.

FIG. 4 is a flow chart of a symbol selection method.

FIG. 5 is a flow chart of a method of operating a gaming device.

FIGS. 6A and 6B show another flow chart of a method of operating a gaming device.

FIGS. 7 to 22 are example screen displays.

### DETAILED DESCRIPTION

Example embodiments are described in which an EGM maintains a count of designated symbols and awards a feature game when the count reaches a triggering value which may be kept hidden or a “mystery” from the player(s). In an advantageous example, the designated symbols can be selected in base game instances and feature game instances. In other examples, the designated symbols may only occur in one of the base game or the feature game. In an example, the designated symbols are linked to an alternative mechanism for triggering the feature game. In an example, the designated symbols are prize symbols, sometimes referred to as a “cash on reels” symbols, that result in an award of the prizes represented by the prize symbols when prize symbols are selected during a feature game. In an example, the feature game is a hold-and-spin type feature game where selected prize symbols are held for subsequent game instances.

The technical problems addressed herein include at least one of: (i) inability of known systems to randomly determine ranges for a reset value for a designated symbol counter and/or a reset trigger value while hiding the reset trigger value from players; (ii) inability of known systems to dynamically queue instances of a feature game before or while an instance of the feature game is occurring; (iii) inability of known systems to communicate that one or more instances of a feature game are queued before or while an instance of the feature game is occurring; and (iv) inability of known systems to efficiently communicate when an instance of a feature game is triggered (e.g., and which instance of the feature game is being triggered when one or more instance of the feature game are queued).

The resulting technical effects and/or technical benefits achieved by this disclosure include at least one of: (i) ability to randomly determine ranges for a reset value for a designated symbol counter and/or a reset trigger value while hiding the reset trigger value from players; (ii) ability to dynamically queue instances of a feature game before or while an instance of the feature game is occurring; (iii) ability to communicate that one or more instances of a feature game are queued before or while an instance of the feature game is occurring; (iv) ability to efficiently communicate when an instance of a feature game is triggered (e.g., and which instance of the feature game is being triggered when one or more instance of the feature game are queued); (v) displaying large quantities of complex information in a relatively small display area; (vi) communicating complex information with easy-to-understand animations on a display; (vii) efficiently communicating different game rules on a display during game play; and (ix) providing versatility as to which devices (e.g., EGMs, mobile devices, etc.) the games described herein may be played on because of the efficient display area designs described herein.

Various interface improvements are provided herein to efficiently and effectively communicate information. For instance, during play of an electronic game, as described herein, various animations are provided to communicate which symbols are causing a designated symbol counter to increment, when a feature game is triggered, and/or which instance of the feature game is triggered (e.g., when one or more instances of the feature game are queued).

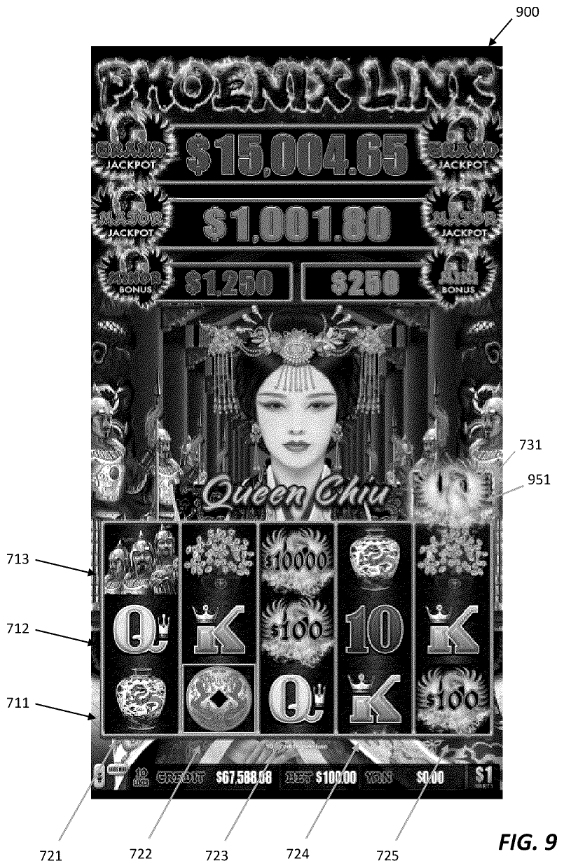

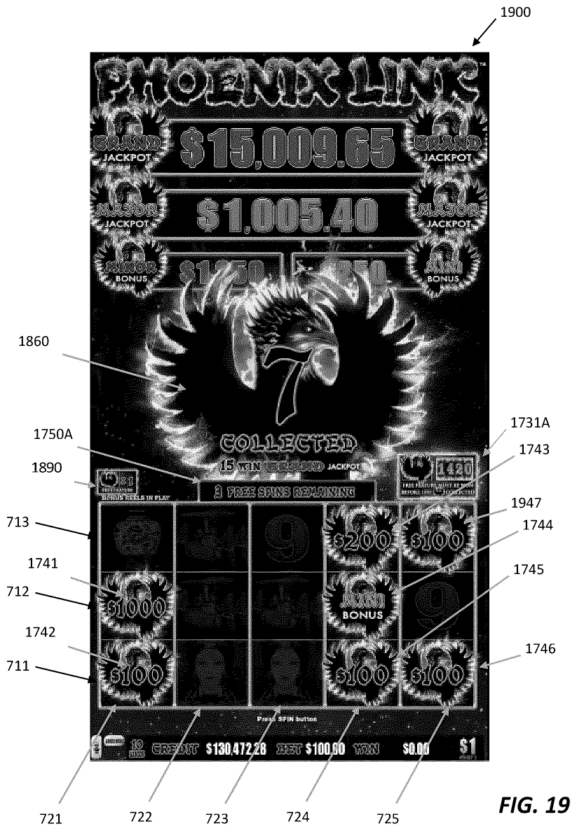

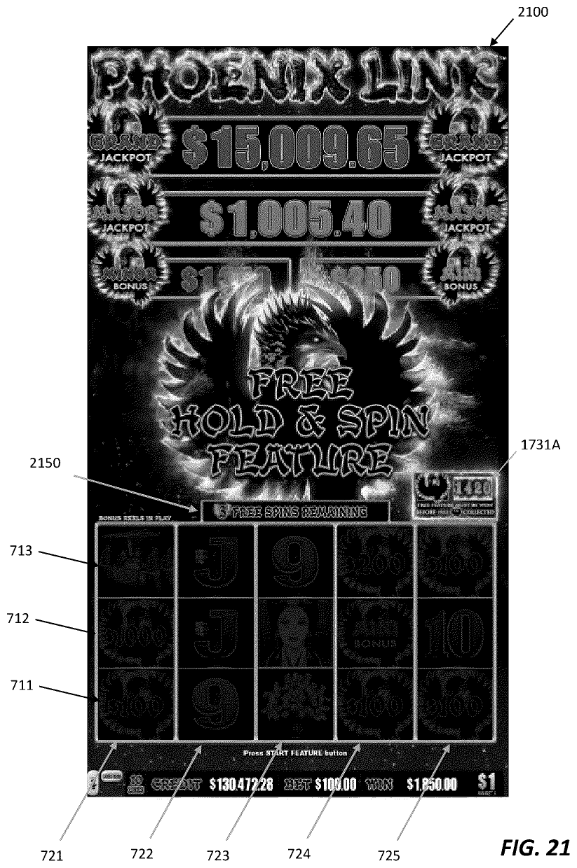

As an example, when a first instance of a feature game is triggered, a phoenix animation may be provided and displayed as originating at the designated symbol counter and changing reels from base game reels to feature game reels (e.g., see FIGS. 9-11). If one or more additional instances of the feature game are queued, an icon may be displayed (e.g., see FIG. 19). When an additional instance of the feature game is queued, the icon may be removed (e.g., see FIG. 21) and/or a counter associated with the icon may be decremented.

Example embodiments described herein may be provided in combination or in isolation to summarize and present game mechanics in a manner that improves the efficiency of computer systems (e.g., electronic gaming systems including electronic gaming devices). Each example system provides an improved user interface displaying a limited set of information to players, potentially within a small screen, such that players can more quickly understand the current status of the game. The systems and methods provide improved display device functionality (e.g., on a gaming device) by providing multiple visual indicators that communicate game mechanics described herein to players. The systems and methods provided herein also improve display and device efficiency by eliminating the need for complex information pages describing game mechanics to players. Because of at least the easily-understood animations, symbols, and indicators displayed, the games described herein can be played and understood on a single screen substantially smaller than some of the EGMs described herein (e.g., a mobile device such as a cell phone), thus removing the need for multiple displays with complex information screens including lengthy text.

Further, various weighted tables and/or RNG calls may be utilized. For instance, the process of resetting the trigger value may include first selecting a new start value “S” for the trigger counter and then selecting a trigger value “T” between the selected new start value S and a maximum value “M”. In an example, a processor uses a random number generator to randomly select start value S between a floor value “F” and a ceiling value “C”. That is, the random selection is such that F≤S≤C. In an example, the floor value is 100 and the ceiling value is 1500. In some examples, the possible values of S are stored in a weighted table with weightings that control the relative probability of specific values being selected. For example, the weightings may be such that values in first range are more likely to be selected than in second range. Advantageously, the floor value avoids low starting values for the starting value that may discourage game play. In an example, the processor then selects T using the RNG to be in the range S<T≤M. T is stored in memory and is not communicated to the player until a next trigger event.

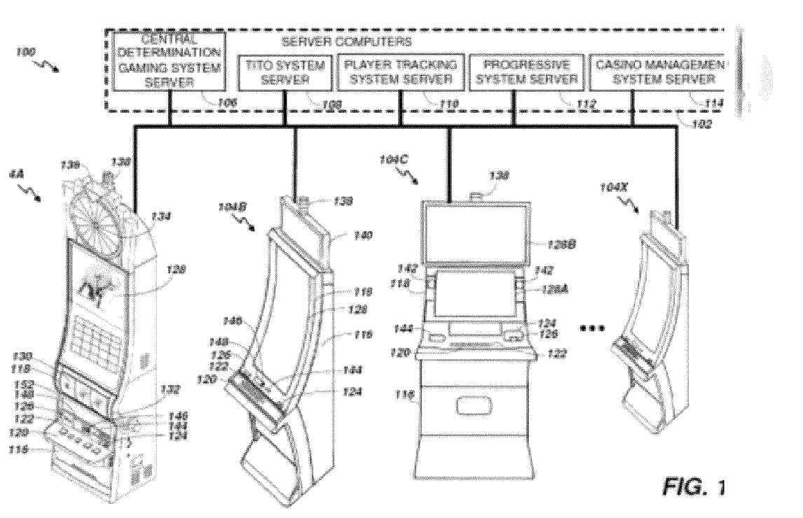

FIG. 1 illustrates several different models of EGMs which may be networked to various gaming related servers. The present embodiments can be configured to work as a system 100 in a gaming environment including one or more server computers 102 (e.g., slot servers of a casino) that are in communication, via a communications network, with one or more gaming devices 104A-104X (EGMs, slots, video poker, bingo machines, etc.). The gaming devices 104A-104X may alternatively be portable and/or remote gaming devices such as, but not limited to, a smart phone, a tablet, a laptop, or a game console.

Communication between the gaming devices 104A-104X and the server computers 102, and among the gaming devices 104A-104X, may be direct or indirect, such as over the Internet through a website maintained by a computer on a remote server or over an online data network including commercial online service providers, Internet service providers, private networks, and the like. In other embodiments, the gaming devices 104A-104X may communicate with one another and/or the server computers 102 over RF, cable TV, satellite links and the like.

In some embodiments, server computers 102 may not be necessary and/or preferred. For example, the present embodiments may, in one or more embodiments, be practiced on a stand-alone gaming device such as gaming device 104A, gaming device 104B or any of the other gaming devices 104C-104X. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket printer 126.

In FIG. 1, gaming device 104A is shown as a Relm XL™ model gaming device manufactured by Aristocrat® Technologies, Inc. As shown, gaming device 104A is a reel machine having a gaming display area 118 including a number (typically 3 or 5) of mechanical reels 130 with various symbols displayed on them. The reels 130 are independently spun and stopped to show a set of symbols within the gaming display area 118 which may be used to determine an outcome to the game. In embodiments where the reels are mechanical, mechanisms can be employed to implement greater functionality. For example, the boundaries of the gaming display area boundaries of the gaming display area 118 may be defined by one or more mechanical shutters controllable by a processor. The mechanical shutters may be controlled to open and close, to correspondingly reveal and conceal more or fewer symbol positions from the mechanical reels 130. For example, a top boundary of the gaming display area 118 may be raised by moving a corresponding mechanical shutter upwards to reveal an additional row of symbol positions on stopped mechanical reels. Further, a transparent or translucent display panel may be overlaid on the gaming display area 118 and controlled to override or supplement what is displayed on one or more of the mechanical reel(s).

In many configurations, the gaming device 104A may have a main display 128 (e.g., video display monitor) mounted to, or above, the gaming display area 118. The main display 128 can be a high-resolution LCD, plasma, LED, or OLED panel which may be flat or curved as shown, a cathode ray tube, or other conventional electronically controlled video monitor.

In some embodiments, the bill validator 124 may also function as a “ticket-in” reader that allows the player to use a casino issued credit ticket to load credits onto the gaming device 104A (e.g., in a cashless ticket (“TITO”) system). In such cashless embodiments, the gaming device 104A may also include a “ticket-out” printer 126 for outputting a credit ticket when a “cash out” button is pressed. Cashless TITO systems are well known in the art and are used to generate and track unique bar-codes or other indicators printed on tickets to allow players to avoid the use of bills and coins by loading credits using a ticket reader and cashing out credits using a ticket-out printer 126 on the gaming device 104A. In some embodiments a ticket reader can be used which is only capable of reading tickets. In some embodiments, a different form of token can be used to store a cash value, such as a magnetic stripe card.

In some embodiments, a player tracking card reader 144, a transceiver for wireless communication with a player's smartphone, a keypad 146, and/or an illuminated display 148 for reading, receiving, entering, and/or displaying player tracking information is provided in gaming device 104A. In such embodiments, a game controller within the gaming device 104A can communicate with the player tracking server system 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some embodiments, the information panel(s) 152 may be implemented as an additional video display.

Gaming devices 104A have traditionally also included a handle 132 typically mounted to the side of main cabinet 116 which may be used to initiate game play.

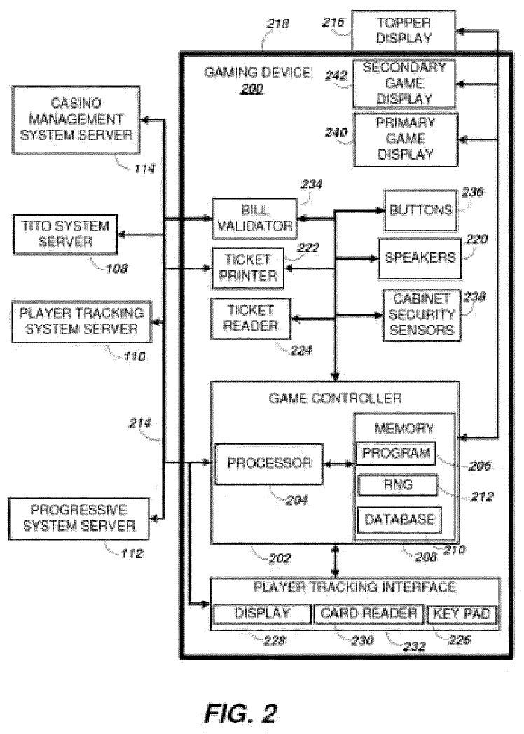

Many or all the above described components can be controlled by circuitry (e.g., a gaming controller) housed inside the main cabinet 116 of the gaming device 104A, the details of which are shown in FIG. 2.

Note that not all gaming devices suitable for implementing the present embodiments necessarily include top wheels, top boxes, information panels, cashless ticket systems, and/or player tracking systems. Further, some suitable gaming devices have only a single game display that includes only a mechanical set of reels and/or a video display, while others are designed for bar counters or table tops and have displays that face upwards.

An alternative example gaming device 104B illustrated in FIG. 1 is the Arc™ model gaming device manufactured by Aristocrat® Technologies, Inc. Note that where possible, reference numerals identifying similar features of the gaming device 104A embodiment are also identified in the gaming device 104B embodiment using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some embodiments, topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the landscape display 128A may have a curvature radius from top to bottom, or alternatively from side to side. In some embodiments, display 128A is a flat panel display. Main display 128A is typically used for primary game play while secondary display 128B is typically used for bonus game play, to show game features or attraction activities while the game is not in play or any other information or media desired by the game designer or operator.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2 is a block diagram depicting exemplary internal electronic components of a gaming device 200 connected to various external systems. All or parts of the example gaming device 200 shown could be used to implement any one of the example gaming devices 104A-X depicted in FIG. 1. The games available for play on the gaming device 200 are controlled by a game controller 202 that includes one or more processors 204 and a game that may be stored as game software or a program 206 in a memory 208 coupled to the processor 204. The memory 208 may include one or more mass storage devices or media that are housed within gaming device 200. Within the mass storage devices and/or memory 208, one or more databases 210 may be provided for use by the program 206. A random number generator (RNG) 212 that can be implemented in hardware and/or software is typically used to generate random numbers that are used in the operation of game play to ensure that game play outcomes are random and meet regulations for a game of chance. In some embodiments, the random number generator 212 is a pseudo-random number generator.

Alternatively, a game instance (e.g., a play or round of the game) may be generated on a remote gaming device such as a central determination gaming system server 106 (not shown in FIG. 2 but see FIG. 1). The game instance is communicated to gaming device 200 via the network 214 and then displayed on gaming device 200. Gaming device 200 may execute game software, such as but not limited to video streaming software that allows the game to be displayed on gaming device 200. When a game is stored on gaming device 200, it may be loaded from a memory 208 (e.g., from a read only memory (ROM)) or from the central determination gaming system server 106 to memory 208. The memory 208 may include RAM, ROM or another form of storage media that stores instructions for execution by the processor 204.

The gaming device 200 may include a topper display 216 or another form of a top box (e.g., a topper wheel, a topper screen, etc.) which sits above main cabinet 218. The gaming cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. The player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. Ticket printer 222 may be used to print tickets for a TITO system server 108. The gaming device 200 may further include a bill validator 234, buttons 236 for player input, cabinet security sensors 238 to detect unauthorized opening of the cabinet 218, a primary game display 240, and a secondary game display 242, each coupled to and operable under the control of game controller 202.

Gaming device 200 may be connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

Gaming devices, such as gaming devices 104A-104X, 200, are highly regulated to ensure fairness and, in many cases, gaming devices 104A-104X, 200 are operable to award monetary awards (e.g., typically dispensed in the form of a redeemable voucher). Therefore, to satisfy security and regulatory requirements in a gaming environment, hardware and software architectures are implemented in gaming devices 104A-104X, 200 that differ significantly from those of general-purpose computers. Adapting general purpose computers to function as gaming devices 200 is not simple or straightforward because of: 1) the regulatory requirements for gaming devices 200, 2) the harsh environment in which gaming devices 200 operate, 3) security requirements, 4) fault tolerance requirements, and 5) the requirement for additional special purpose componentry enabling functionality of an EGM. These differences require substantial engineering effort with respect to game design implementation, hardware components and software.

When a player wishes to play the gaming device 200, he/she can insert cash or a ticket voucher through a credit input mechanism such as a coin acceptor (not shown) or bill validator 234 to establish a credit balance on the gamine machine. The credit balance is used by the player to place wagers on instances of the game and to receive credit awards based on the outcome of winning instances. The credit balance is decreased by the amount of each wager and increased upon a win. The player can add additional credits to the balance at any time. The credit balance may be stored in a meter in memory 208 (or in a separate hardware meter). In some embodiment, memory 208 implements a credit meter to monitor to the credit balance and has a win meter that monitors any amounts won during any game instance(s) resulting from the wager. The balance of the win meter is transferred to the credit meter prior at the conclusion of the game instances. The player may also optionally insert a loyalty club card into the card reader 230. In some embodiments, the loyalty club card may also act as a credit input mechanism, by allowing a player to transfer funds from a centrally stored balance in order to establish a credit balance. During the game, the player views the game outcome on the game displays 240, 242. Other game and prize information may also be displayed.

When the player is done, he/she cashes out the credit balance (typically by pressing a cash out button to receive a ticket from the ticket printer 222). The ticket may be “cashed-in” for money or inserted into another machine to establish a credit balance for play.

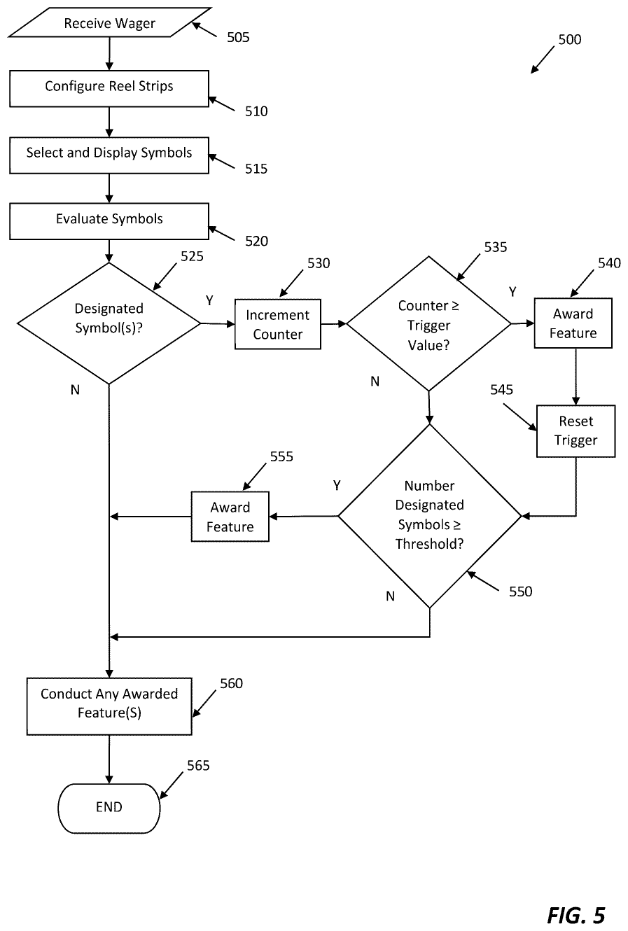

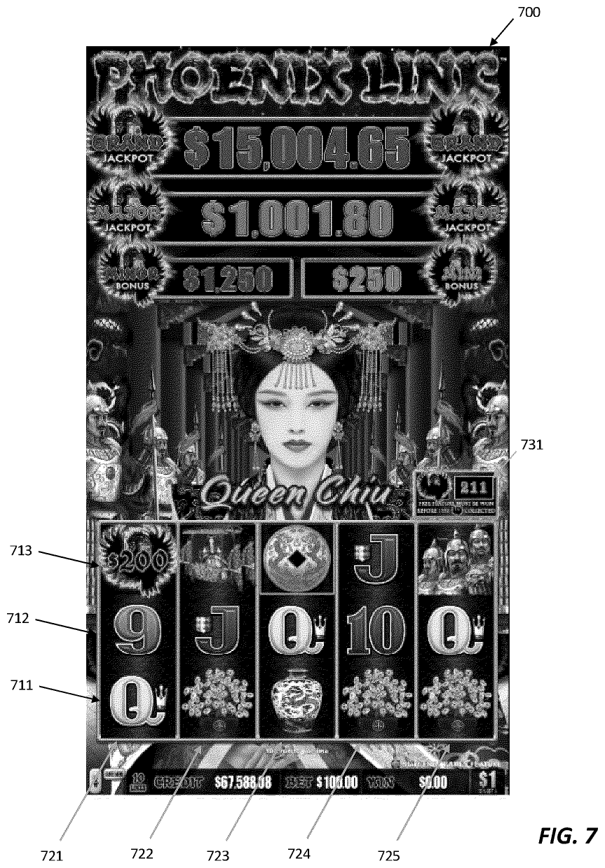

FIG. 5 is a flow chart of an example embodiment of a method 500 of operating a gaming device. At step 505, the processor 204 initiates a first game instance (e.g., a base game) in response to receiving a wager (e.g., in response to a player making a wager selection using buttons as described above). FIG. 7 shows an example screen display 700 of the base game prior to symbols being selected, where the displayed symbols are from an immediate prior base game instance. In the example, symbols are displayed at fifteen symbol positions including of five columns of symbol positions 721-725 and three rows 711-713 of symbol positions. Screen display 700 also includes a current value of a designated symbol counter 731 stored in memory, here the current value is “211”.

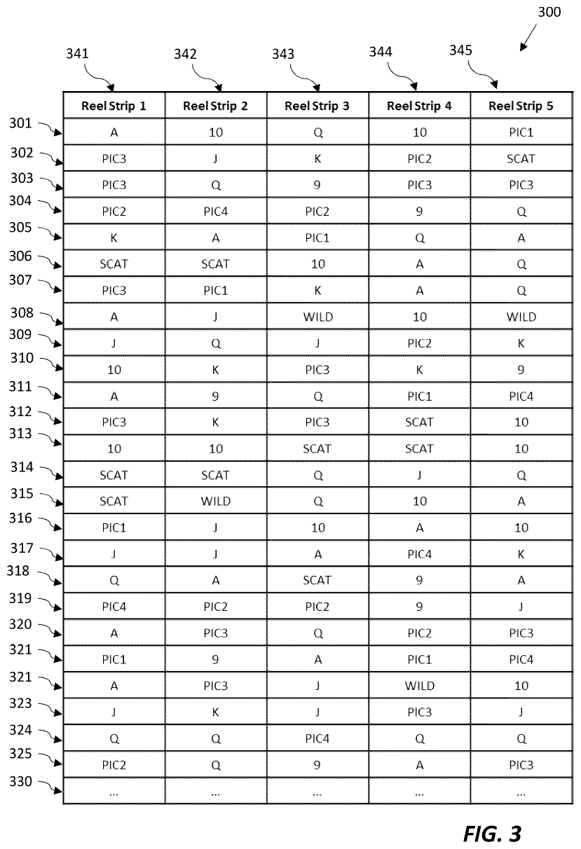

At step 510, the processor 204 configures the reel strips for a current game instance, in this respect, FIG. 3 illustrates an example of a set 300 of five reel strips 341, 342, 343, 344, 345 for use in base game instances. In the example, for illustrative purposes, twenty-five reel strip positions 301-325 are shown for each reel strip 341-345. Each reel strip position of each reel has a symbol. For example, a “Wild” symbol occupies the twenty-first reel strip position 321 of the fourth reel 344. The symbols shown on the reel strip are generally indicative of symbols that may be employed in the embodiments but it will be appreciated that their visual appearance and the composition of the reel strip will depend on factors such as the visual theme of the game and desired return to player. That is, other reels strips to those illustrated in FIG. 3 can be used, for example, reel strips where two or more wild symbols are placed at consecutive reel strip positions of a reel strip. Symbol position 330 indicates that the reel strips 341-345 may have more symbols than illustrated. For example, the reel strips 341-345 could have between 30 and 100 reel strip positions with the last reel strip position of a respective reel strip being treated as contiguous with the first reel strip position 301 as would be the case with a mechanical reel. The actual lengths of the game reel strips depend on factors such as the number of wild symbols (in general, the more wilds there are, the longer the reel strip needs to be to maintain the target RTP), and volatility (in general, the higher the prize value is, the longer the reel strip needs to be to lower the hit rate to maintain the target RTP). In some examples, the reel strips associated with different columns may be of different lengths to one another.

In the examples, the reel strips include a plurality of configurable symbol positions, here designated as “SCAT” (e.g., at the sixth symbol position 306 of the first and second reel strips 341,342), and these symbol positions are configured at step 510 by processor 204 with configuring symbols as part of each base game instance. That is, in this example, the reel strips are configured for each base game instance.

In this example, the reel strips are configured by randomly selecting a prize symbol from a set of prize symbols having a plurality of different prize values. In an example, the prize symbols correspond to dollar values, and/or bonus or jackpot prizes. In other examples, prize symbols may be credit values. In some examples, the value of the prize symbols may be related to an amount wagered (e.g. with relatively higher prize values for relatively higher wagers). In an example, processor 204 conducts a random determination using RNG 212 and a weighted table stored in memory 208 that defines the relative probabilities of specific prize symbols being selected in order to determine what type of symbol should be configured at each configurable symbol position.

At step 515, the processor 204 selects symbols for a spinning reel base game using the configured reel strips and controls the display 240 to display the selected symbols. In this example, symbols are selected from five configured reel strips for display in respective ones of the five columns of symbol positions 721-725 with three symbols being selected from each reel strip.

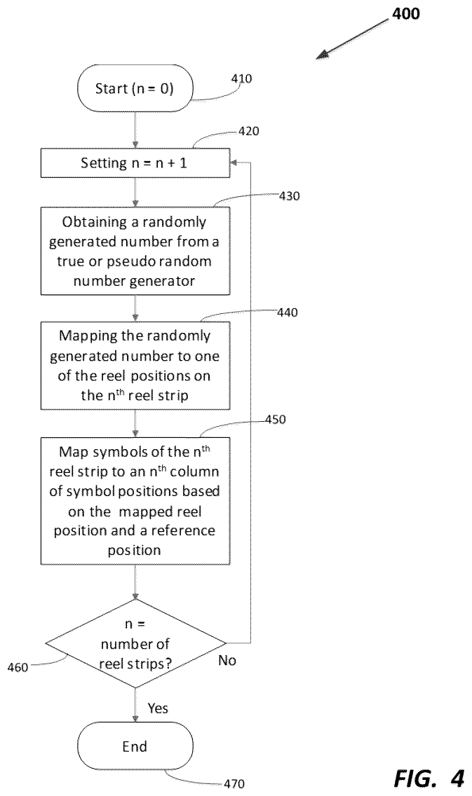

FIG. 4 is a flow chart of an example method 400 carried out by the processor 204 to select symbols at step 515 from reel strips configured at step 510. At step 410, the processor 204 starts the process of selecting symbols with a counter (n) set at zero as symbols have not yet been selected from any reel strips. At step 420, the processor 204 increments the counter. In the first iteration, the counter is set to 1 to reflect that symbols are to be selected from a first reel strip. At step 430, the processor obtains a randomly generated number from a true or pseudo random number generator 212. At step 440 the processor maps the generated number to one of the reel positions of the nth reel strip. In the first iteration, this is the first reel strip. To map the generated number to one of the reel positions, the possible values that can be returned from the RNG 212 are divided into ranges and associated with specific ones of the reel positions in memory 208. In one example, these ranges are stored as a look-up table. In one example, the ranges are each the same size so that each of the reel strip positions has the same chance of been selected. In other examples, the ranges may be arranged to weight the relative chances of selecting specific reel strip positions.

At step 450, the processor 204 maps symbols of the nth reel strip to and nth column of symbol display positions based on the mapped reel position and a reference position. In an example, the reference position is the bottom position of the symbol positions of each column of symbol positions. In this example, the selected reel position (and hence the symbol at this position) is mapped to the bottom symbol position of the column. Referring to the example reel strips of FIG. 3, if the value returned by the RNG 212 is mapped to reel position 313 when three symbols are being selected from each reel, then for the first reel strip 341, “10” is mapped to a bottom symbol position in bottom row 711, “PIC3” symbol is mapped to a middle symbol position in middle row 712, and “A” symbol is mapped to a top symbol position in top row 713.

At step 460, the processor 204 determines whether symbols have been selected for all of the reel strips, and if not the processor 204 reverts to step 420 and iterates through steps 430, 440 and 450 until it is determined at step 460 that symbols have been selected from all n reel strips and mapped to all n columns of symbol positions after which the symbol selection process ends 470. Different numbers of symbols may be mapped to different numbers of symbol positions.

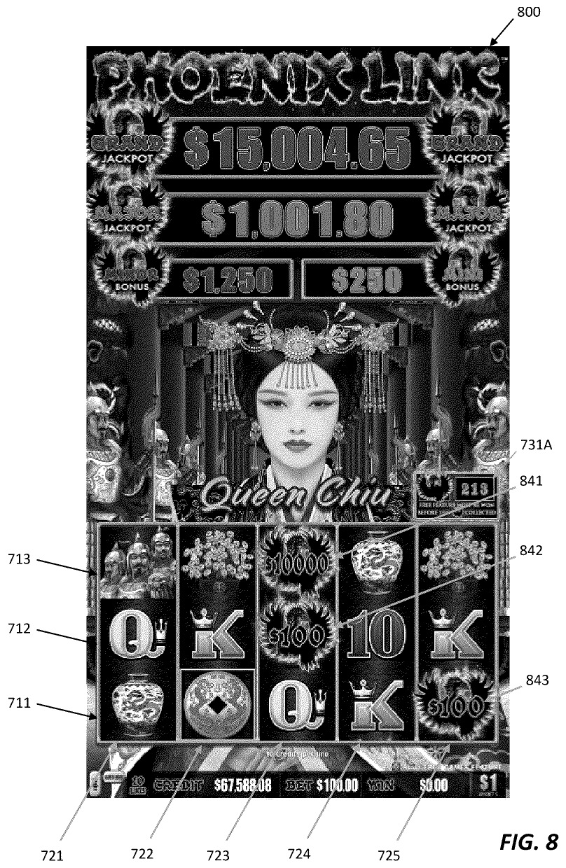

After the symbols of all reel strips have been mapped to symbol positions, the processor 204 controls display 240 to display them at the symbol positions. FIG. 8 shows an example screen display of symbols selected in a game instance subsequent to that shown in FIG. 7.

After the symbols are selected, at step 520, processor 204 evaluates the selected symbols for one or more winning combinations based on a pay table stored in memory 208. In this example, processor 204 applies a “pay line” type evaluation by processing the selected symbols to identify instances of the same symbol appearing on defined pay lines including one symbol position from each of the columns 821-825 starting with (and including) the first column. Upon there being one or more winning combinations, processor 204 makes an award, for example, by adding credit amounts defined by the pay table and the amount wagered to a win meter or a credit meter in memory 208.

At step 525, processor 204 determines whether the selected symbols include one or more designated symbols. In this example, the designated symbols are prize symbols as this is an effective combination with a feature game where prize symbols are also employed in hold and spin game instances. In other examples, alternative designated symbols may be employed. If processor 204 makes a positive determination at step 250, processor 204 increments the designated symbol counter 731 on the display 240 and in memory 208 as explained in more detail below. Processor 204 then determines at step 535 whether the selected symbols have caused the designated counter 731 to reach a current trigger value stored in memory 208 and if it does, processor 204 awards a feature game at step 540. FIG. 5 shows a generalized version of this process where the counter 731 is incremented based on the number of designated symbols and the determination at step 535 may be based on whether the counter reaches or exceeds the current trigger value in a current game instance. In the example, shown in connection with the example screen display 800, processor 204 increments the counter individually for each selected prize symbol in a defined order (e.g., left to right, top to bottom) and checks after each increment whether the counter 731 has reached the trigger value in memory.

In this respect, screen display 800 of FIG. 8 shows an example where the symbol selection process has resulted in three prize symbols 841,842,843 being selected. However, in this example, the updated designated symbol counter 731A shows “213” an increment of only two relative to the value shown in screen display 700 of FIG. 7. In this example, this is because the designated symbol counter 731A has reached a trigger value of “213” such that the processor 204 awards a feature game at step 540 and the designated symbol counter does not need to be updated further.

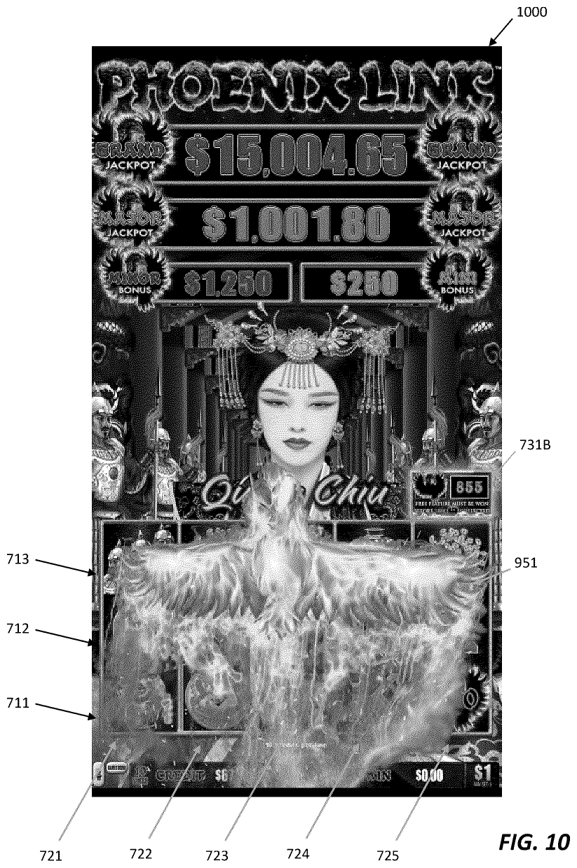

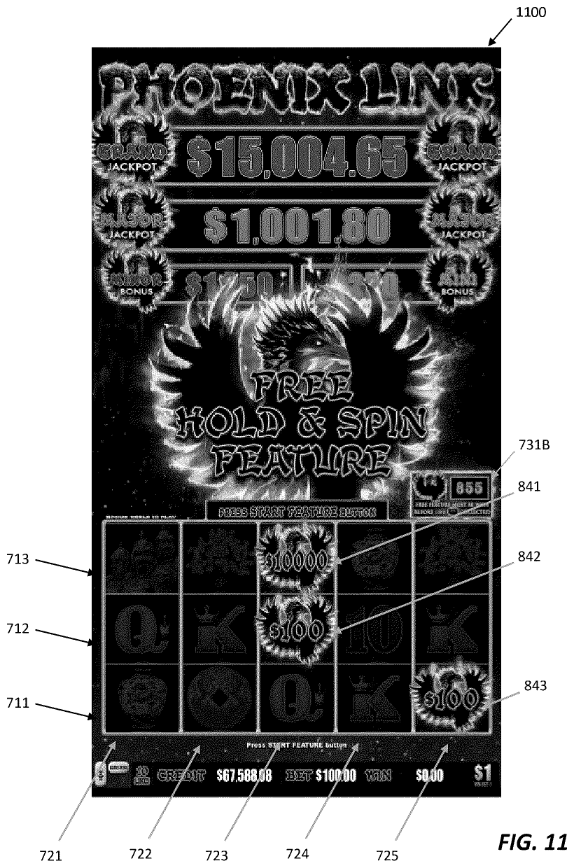

FIG. 9 is an example screen display 900 of the processor 204 controlling display 240 to display part of animation that accompanies award of the feature and transition to a feature game display. Here a Phoenix character 951 is animated as initially appearing over the designated symbol counter 731 and then as moving relative to the display. As shown in screen display 1000 of FIG. 10, the Phoenix character 951 grows and moves over the display 240 to give an effect of moving over the display and “burning” away the base game until the base game is replaced with an initial feature game display as shown in example screen display 1100 of FIG. 11.

It will be observed that in FIGS. 10 and 11, there is an updated current counter value 731B of “855”. In this example, this is a result of the trigger value being reset at step 545. In an example, the process of resetting the trigger value includes first selecting a new start value “S” for the trigger counter and then selecting a trigger value “T” between the selected new start value S and a maximum value “M”. In the example shown in the example screen displays, the illustrated maximum value is “1888”. In an example, processor 204 uses random number generator 212 to randomly select start value S between a floor value “F” and a ceiling value “C”. That is, the random selection is such that F≤S≤C. In an example, the floor value is 100 and the ceiling value is 1500. In some examples, the possible values of S are stored in a weighted table with weightings that control the relative probability of specific values being selected. For example, the weightings may be such that values in first range are more likely to be selected than in second range. Advantageously, the floor value avoids low starting values for the starting value that may discourage game play. In an example, processor 204 then selects T using RNG 212 to be in the range S<T≤M. In the example of FIGS. 10 and 11, S=855 such processor 204 will have used RNG 212 to select T such that 855<T≤1888. T is stored in memory 208 and is not communicated to the player until a next trigger event.

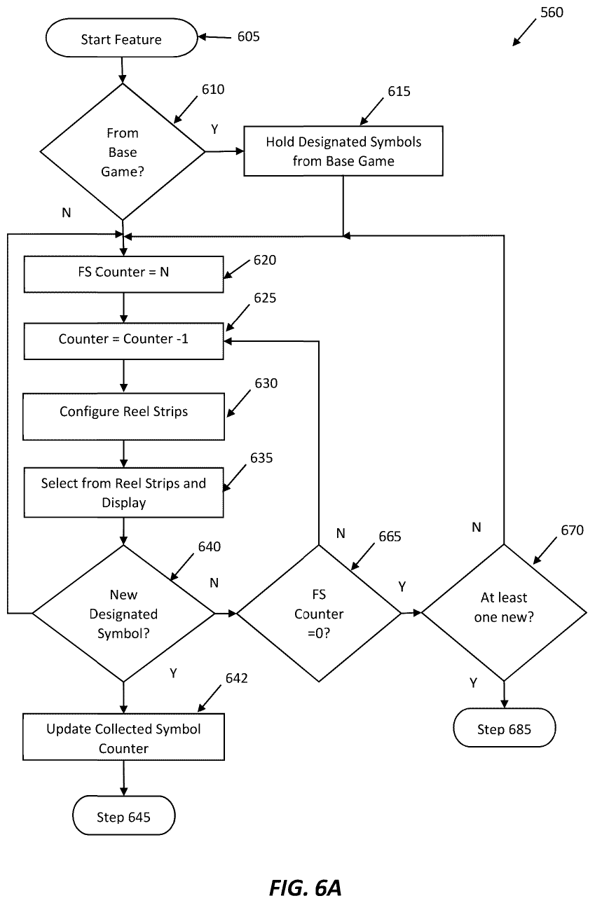

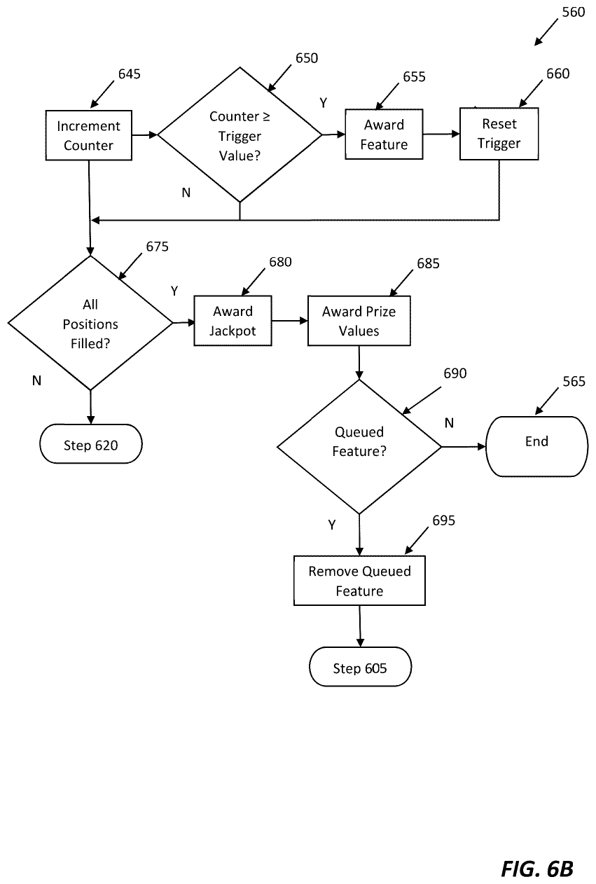

At step 550 processor 204 determines whether an alternative feature trigger including a number of selected designated symbols in a base game instance being greater than or equal to a threshold number is met. In this example, the threshold number is six prize symbols and base game instance outcome shown in the example screen display of FIG. 8 will not meet the alternative trigger criterion such that the processor 204 will proceed to step 560 and conduct the awarded feature game as explained in more detail in conjunction with the flow chart of FIG. 6.

As shown in FIG. 6, at step 605 the feature game is initiated by processor 204 (e.g., by transitioning to the feature display 1100). As indicated by step 610, the manner in which the feature game is initiated by processor 204 depends upon whether the feature game was initiated from the base game or another feature game (as will be described below). Where the feature game has been initiated from a feature game, processor 204 holds 615 the designated symbols from the base game as shown in screen display 1100.

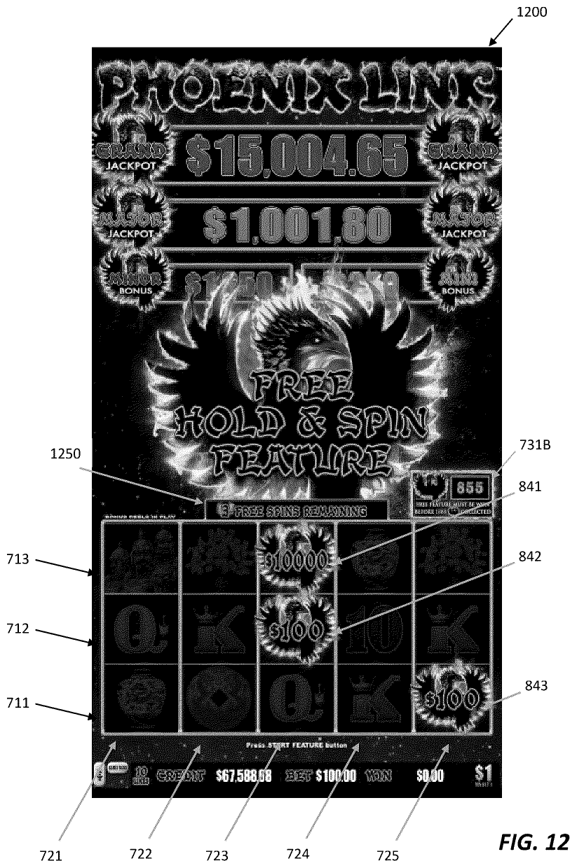

At step 620, processor 204 sets a counter in memory 208 to a number (N) of hold and spin feature game instances or “free spins”, in this example to three game instances as shown by free spin counter 1250 in FIG. 12, which partly defines an end condition for the feature game. In this example, the end condition is that three game instances in a row are conducted by the gaming device 200 and at least one additional prize symbol has been selected subsequent to commencement of the feature game. Advantageously, this end condition ensures that when a feature game is initiated, at least one additional prize symbol must be selected by the processor before the feature game will end. In some examples, the end condition may be that a defined number of game instances in a row are conducted by the gaming device and at least one prize symbol is displayed, to ensure at least one prize symbol is selected in feature games initiated with no held symbols (as will be described below).

At step 625, processor 204 decrements the counter by one to reflect the initiation of a game instance. At step 630, processor 204 configures feature game reel strips stored as part of reel data in memory using a process analogous to that described above. In this example, each feature game reel strip includes configurable symbol positions and “blank” symbol positions. The “blank” symbol positions are blank in the sense that they do not contribute to the outcome of the feature game and may be displayed, for example, as greyed out symbols corresponding to the symbols of the base game reel strips.

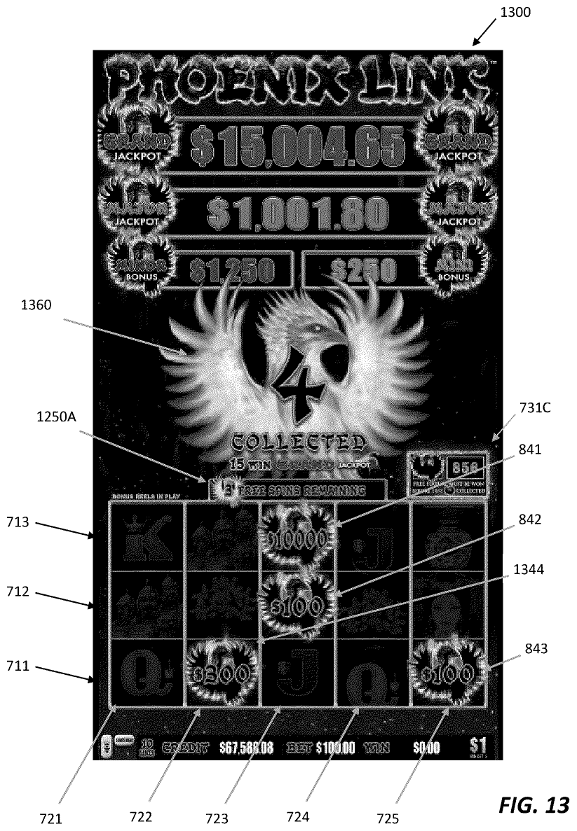

At step 635, processor 204 selects symbols from the configured reel strips for a current feature game instance, which on a first iteration will be the first feature game instance. In this respect, in an example, in the feature game, symbols are independently selected from reel strips for individual symbol positions such that the number of reel strips used depends on the number of unoccupied symbol positions. In some examples selecting symbols may include the processor 204 randomly associating reel strips with symbol positions and then randomly selecting a stopping position for the respective reel strips. In some examples, a reel strip may be configured to control a probability of all symbol positions being occupied by a prize symbol and may be randomly associated with a symbol position before other reel strips are associated with symbol positions to ensure that it is used in each feature game instance. FIG. 13 is an example of screen display 1300 that shows the outcome of a symbol selection process of an example first feature game instance in which an additional prize symbol 1344 has been selected.

At step 640, processor 204 makes a determination as to whether a new designated symbol has been selected in a current feature game instance, and in the case of FIG. 13 will make a positive determination and proceed to step 642, during which processor 204 updates a collected symbol counter 1360 on display 240, here to show “4 Collected. 15 Win Grand Jackpot”.

At step 645, processor 204 updates the designated symbol counter 731C, here to show an updated value of “856”. Then at step 650, processor 204 makes determination as to whether the counter has reached the threshold in the same manner described in relation to FIG. 5. In this example, processor 204 makes a negative determination at step 650.

At step 675, processor 204 determines whether all 15 symbol positions are filled (that is, whether fifteen prize symbols have been selected. If processor 204 were to make a positive determination at step 675, processor 204 would proceed to step 680 and award the Grand Jackpot prize (here, the highest jackpot prize), however, in the case of the example of FIG. 13, only four prize symbols are collected and processor 204 will make a negative determination and then iterate back to step 620 and reset the free spin counter to the starting value, here to “3” as shown in updated free spin counter 1250A.

Processor 204 iterates through steps 620 to 640 as described above and generates additional game instance outcomes. In example, game instances where processor 204 makes a negative determination at step 640, at step 665, processor 204 makes a determination at step 665 as to whether the free spin counter has reached zero, and, if not, iterates to step 625 and decrements the free spin counter.

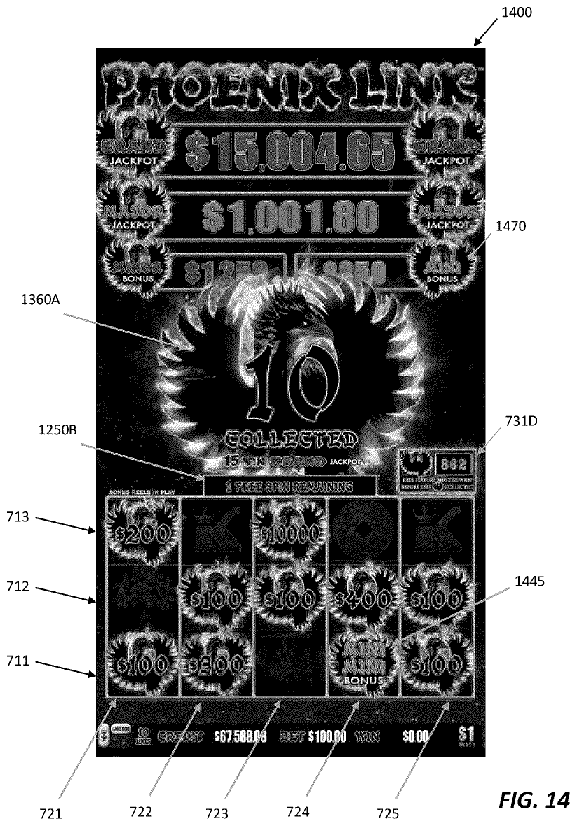

FIG. 14 is an example screen display 1400 showing a game outcome of one of these additional game instances where as a result of the intervening game instances since screen display 1300, six further prize symbols have been selected. As a result, processor 204 has updated collected symbol counter 1360A on display 240, here to show “10 Collected. 15 Win Grand Jackpot, and designated symbol counter 731D to show an updated value of “862”. The example screen display 1400, shows an indicative game instance where the two prior game instances have not resulted in a new prize symbol being selected such that free spin counter 1250B shows “1 Free Spin Remaining”.

FIG. 14 also shows an example where a prize symbol 1445 is related to a bonus prize, here the “Mini Bonus” prize 1470. In this example, the prize symbol 1445 includes the text “Mini Mini Bonus” to indicate that the Mini bonus prize will be awarded twice.

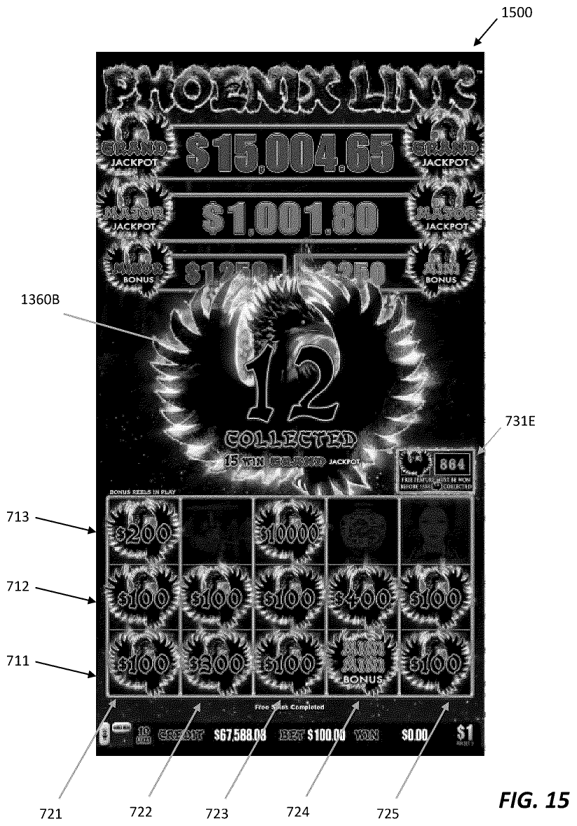

FIG. 15 is an example screen display 1500 after a last free spin where free spin counter has reached zero. In this respect, it will be observed that the free spin counter has been removed from screen display 1500. In this example, since screen display 1400, two further prize symbols have been selected. As a result, processor 204 has updated collected symbol counter 1360B on display 240 to show “12 Collected. 15 Win Grand Jackpot”, and designated symbol counter 731E to show an updated value of “864”.

In this example, processor 204 will make a positive determination at step 665. At step 670, processor 204 conducts a check as to whether at least one designated symbol has been selected since the feature game was initiated. In this case, processor 204 will make a positive determination and proceed to step 685. Where processor 204 makes a negative determination at step 670, processor 204 iterates back to step 620 and resets the free spin counter to the starting value, in this example to three. In this way, game instances will be conducted by processor 204 until at least one prize symbol is selected ensuring there will be at least some prize awarded from the feature game. In another example, processor 204 may increment the free spin counter by one and iterate back to step 625 upon making a negative determination at step 670.

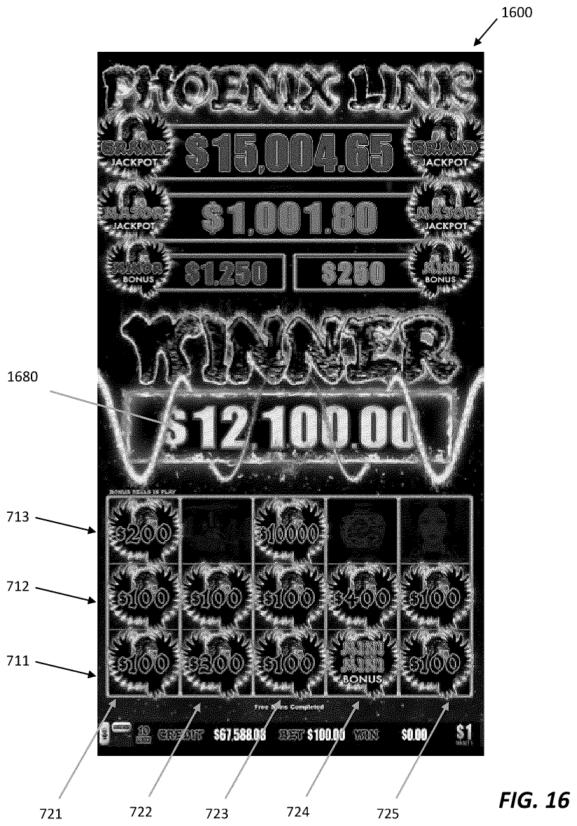

When processor 204 proceeds to step 685, processor 204 awards the prize values shown on the collected prize symbols. FIG. 16 shows an example screen display 1600 where processor 204 has made a prize award of $12,100 based on the values on the prize values (including the twice awarded Mini bonus).

At step 690, processor 204 makes a determination as to whether there is a queued feature game, and in this example, will make a negative determination after which game play ends 565.

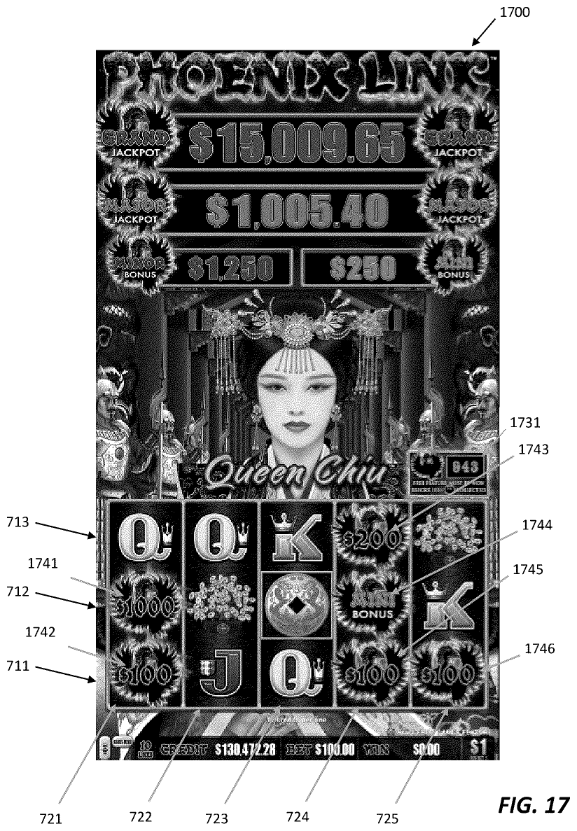

FIG. 17 shows an example screen display from a base game instance generated by processor 204 selecting symbols at step 515. In this example, processor 204 has selected six prize symbols 1741-1746. Accordingly, in this example processor 204 will make a positive determination at step 550 and award a feature game at step 555. In this example, designated/prize symbol counter 1731 has a value of 943 after the six prize symbols have been accounted for, which does not correspond to a trigger value.

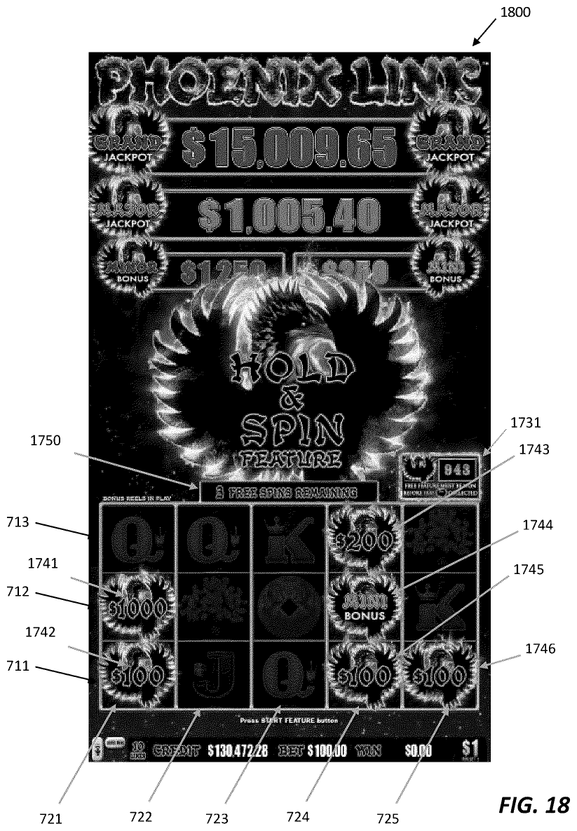

FIG. 18 is an example screen display 1800 after processor 204 transitions to a feature game display with the prize symbols 1741-1746 held from the base game with free spin counter 1750 indicating that three free spins remain.

FIG. 19 is an example of a subsequent screen display 1900 where when processor 204 has incremented the designated symbol counter at step 645, processor 204 has made a positive determination at step 650 that the trigger value has been reached and awarded an additional feature game as indicated by queued feature game indicator 1890, which in this example indicates that one feature game is queued. Processor 204 will continue to conduct the initially awarded feature game until and end condition is met and then conduct the queued feature game. Processor 204 has also reset the counter 1731A to a new starting value of “1420” and also updated the trigger value in memory 208.

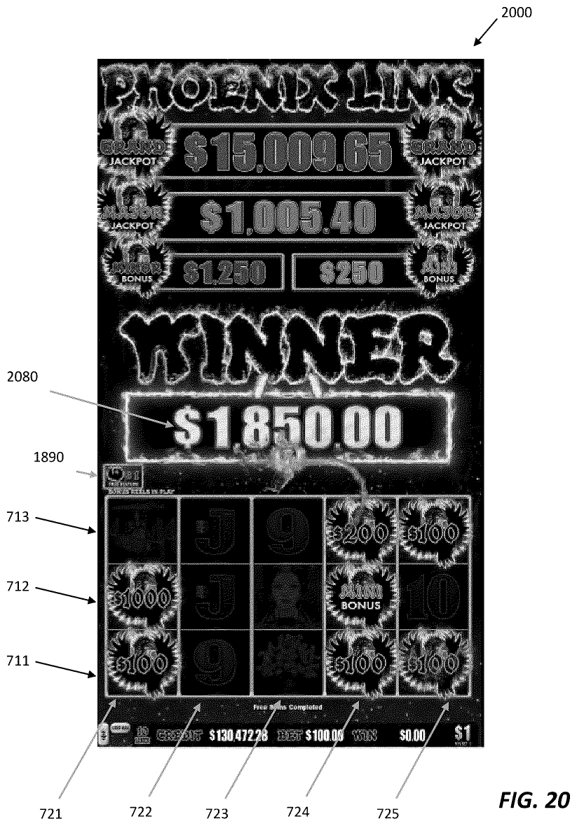

FIG. 20 is an example of a prize award screen display following conclusion of the initial feature game, showing a prize award 2080 of “$1850.00” for the initial feature game and still showing a queued feature indicator 1890. In this example, processor 204 will make a positive determination at step 690 that there is a queued feature and at step 695 processor 204 will remove the queued feature before iterating back to step 605 and starting the additional feature. In this example, processor 204 will make a negative determination at step 610 such that there will be no held symbols at the start of the additional feature game.

FIG. 21 is an example screen display 2100 at the start of the second feature game following step 620. As shown in screen display 2100, the second feature game starts with no held symbols and with the same prize symbol counter value 1731A, here “1420”. Free spin counter 2150 is set to the initial value of three at step 620. Processor 204 then iterates through the step of FIG. 6 in the same manner described above.

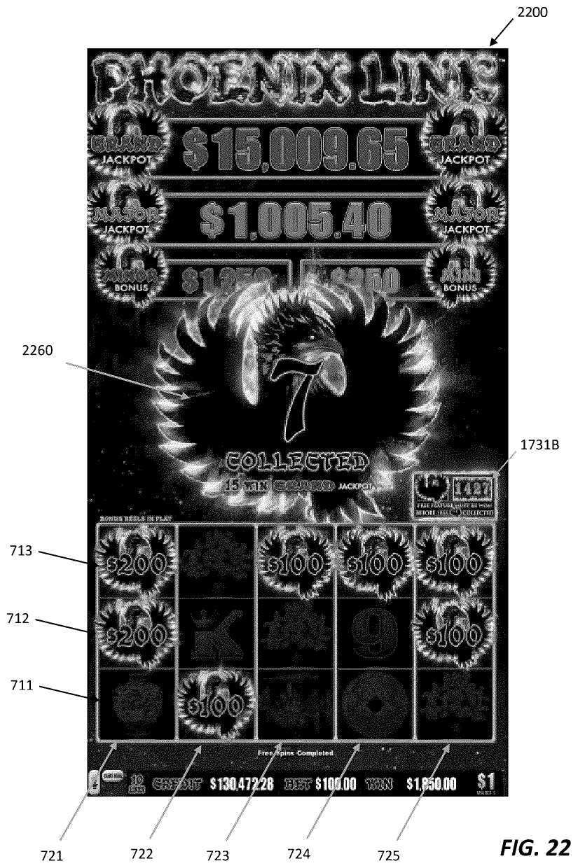

FIG. 22 is an example screen display at the conclusion of the additional feature game with collected symbol counter 2260 showing that seven prize symbols were collected during the additional feature game. Designated symbol counter 1731B has also been updated to the value “1427” to reflect the number of collected symbols. Processor 204 makes a positive determination at step 665, a negative determination at step 670, and awards prizes at step 685. As there is no longer a queued feature, processor 204 makes a negative determination at step 690 such that game play ends 565. As indicated above, if during a feature game starting with no held symbols, processor 204 will make a negative determination at step 670 if new designated symbols are collected during the initial three game instances such that the feature game will not end with no prize symbols.

While the invention has been described with respect to the figures, it will be appreciated that many modifications and changes may be made by those skilled in the art without departing from the spirit of the invention. Any variation and derivation from the above description and figures are included in the scope of the present invention as defined by the claims.

What is claimed is:

1. An electronic gaming system comprising:
at least one memory with instructions stored thereon; and
at least one processor in communication with the at least one memory, wherein the instructions, when executed by the at least one processor, cause the at least one processor to:
cause an electronic game including a designated symbol counter to be provided;
cause the designated symbol counter to be incremented based upon display of one or more designated symbols during play of the electronic game; and
based upon the designated symbol counter reaching a trigger value stored in the at least one memory:
cause a feature game to be triggered;
randomly determine a reset value for the designated symbol counter based upon a first random number generator (RNG) call and a first range of values stored in the at least one memory; and
randomly determine a reset trigger value based upon a second RNG call and a second range of values stored in the at least one memory, the second range of values comprising a range between the reset value and a maximum value.

2. The electronic gaming system of claim 1, wherein the first range of values is stored in the at least one memory as including a plurality of sub-ranges each associated with a respective weight, wherein the instructions further cause the at least one processor to randomly determine a sub-range of the plurality of sub-ranges, and wherein the reset value is randomly determined from the sub-range.

3. The electronic gaming system of claim 1, wherein the instructions further cause the at least one processor to, based upon the designated symbol counter reaching the trigger value, cause display of an animation transitioning across a plurality of reels for the electronic game.

4. The electronic gaming system of claim 3, wherein the instructions further cause the at least one processor to, as the animation transitions across the plurality of reels, cause the plurality of reels to change from base game reels to feature game reels.

5. The electronic gaming system of claim 1, wherein the feature game is a second instance of the feature game, and wherein the instructions further cause the at least one processor to cause a first instance of the feature game to be triggered based upon a trigger condition being satisfied in the electronic game.

6. The electronic gaming system of claim 5, wherein the trigger condition comprises a threshold number of designated symbols being displayed in a base game outcome.

7. The electronic gaming system of claim 5, wherein the instructions further cause the at least one processor to, during play of the first instance of the feature game and based upon the second instance of the feature game being triggered, cause display of a queued feature game indicator indicating that the second instance of the feature game will be provided.

8. The electronic gaming system of claim 7, wherein the instructions further cause the at least one processor to:
cause the first instance of the feature game to be provided until an end condition in the first instance of the feature game is satisfied; and
based upon the end condition being satisfied:
cause the queued feature game indicator to stop being displayed; and
cause the second instance of the feature game to be provided.

9. At least one non-transitory computer-readable storage medium with instructions stored thereon that, in response to execution by at least one processor, cause the at least one processor to:
cause an electronic game including a designated symbol counter to be provided;
cause the designated symbol counter to be incremented based upon display of one or more designated symbols during play of the electronic game; and
based upon the designated symbol counter reaching a trigger value stored in the at least one non-transitory computer-readable storage medium:
cause a feature game to be triggered;
randomly determine a reset value for the designated symbol counter based upon a first random number generator (RNG) call and a first range of values stored in the at least one non-transitory computer-readable storage medium; and
randomly determine a reset trigger value based upon a second RNG call and a second range of values stored in the at least one non-transitory computer-readable storage medium, the second range of values comprising a range between the reset value and a maximum value.

10. The at least one non-transitory computer-readable storage medium of claim 9, wherein the first range of values is stored in the at least one non-transitory computer-readable storage medium as including a plurality of sub-ranges each associated with a respective weight, wherein the instructions further cause the at least one processor to randomly determine a sub-range of the plurality of sub-ranges, and wherein the reset value is randomly determined from the sub-range.

11. The at least one non-transitory computer-readable storage medium of claim 9, wherein the instructions further cause the at least one processor to, based upon the designated symbol counter reaching the trigger value, cause display of an animation transitioning across a plurality of reels for the electronic game.

12. The at least one non-transitory computer-readable storage medium of claim 11, wherein the instructions further cause the at least one processor to, as the animation transitions across the plurality of reels, cause the plurality of reels to change from base game reels to feature game reels.

13. The at least one non-transitory computer-readable storage medium of claim 9, wherein the feature game is a second instance of the feature game, and wherein the instructions further cause the at least one processor to cause a first instance of the feature game to be triggered based upon a trigger condition being satisfied in the electronic game.

14. The at least one non-transitory computer-readable storage medium of claim 13, wherein the trigger condition comprises a threshold number of designated symbols being displayed in a base game outcome.

15. The at least one non-transitory computer-readable storage medium of claim 13, wherein the instructions further cause the at least one processor to, during play of the first instance of the feature game and based upon the second instance of the feature game being triggered, cause display of a queued feature game indicator indicating that the second instance of the feature game will be provided.

16. The at least one non-transitory computer-readable storage medium of claim 15, wherein the instructions further cause the at least one processor to:
cause the first instance of the feature game to be provided until an end condition in the first instance of the feature game is satisfied; and
based upon the end condition being satisfied:
cause the queued feature game indicator to stop being displayed; and
cause the second instance of the feature game to be provided.

17. A method of electronic gaming implemented by at least one processor in communication with at least one memory, the method comprising:
causing an electronic game including a designated symbol counter to be provided;
causing the designated symbol counter to be incremented based upon display of one or more designated symbols during play of the electronic game; and
based upon the designated symbol counter reaching a trigger value stored in the at least one memory:
causing a feature game to be triggered;
randomly determining a reset value for the designated symbol counter based upon a first random number generator (RNG) call and a first range of values stored in the at least one memory; and
randomly determining a reset trigger value based upon a second RNG call and a second range of values stored in the at least one memory, the second range of values comprising a range between the reset value and a maximum value.

18. The method of claim 17, further comprising:
based upon the designated symbol counter reaching the trigger value, causing display of an animation transitioning across a plurality of reels for the electronic game; and
as the animation transitions across the plurality of reels, causing the plurality of reels to change from base game reels to feature game reels.

19. The method of claim 17, wherein the feature game is a second instance of the feature game, wherein the method further comprises causing the at least one processor to cause a first instance of the feature game to be triggered based upon a trigger condition being satisfied in the electronic game, and wherein the trigger condition comprises a threshold number of designated symbols being displayed in a base game outcome.

20. The method of claim 19, further comprising:
during play of the first instance of the feature game and based upon the second instance of the feature game being triggered, causing display of a queued feature game indicator indicating that the second instance of the feature game will be provided;
causing the first instance of the feature game to be provided until an end condition in the first instance of the feature game is satisfied; and
based upon the end condition being satisfied:
causing the queued feature game indicator to stop being displayed; and
causing the second instance of the feature game to be provided.
